(19) United States
(12) Patent Application Publication
(10) Pub. No.: US 2025/0390414 A1
(43) Pub. Date: Dec. 25, 2025

(54) METHOD AND APPARATUS WITH FAULT LOCALIZATION

(71) Applicants: Samsung Electronics Co., Ltd., Suwon-si (KR); Korea University Research and Business Foundation, Seoul (KR)

(72) Inventors: Do-Ha HWANG, Suwon-si (KR); Minseok JEON, Seoul (KR); Hakjoo OH, Seoul (KR)

(73) Assignees: Samsung Electronics Co., Ltd., Suwon-si (KR); Korea University Research and Business Foundation, Seoul (KR)

(21) Appl. No.: 19/072,960

(22) Filed: Mar. 6, 2025

(30) Foreign Application Priority Data
Jun. 25, 2024 (KR) 10-2024-0082970

(51) Int. Cl. G06F 11/3604

(52) U.S. Cl. CPC G06F 11/3608

(57) ABSTRACT

A fault localization method is disclosed. The method includes collecting fault data from past versions of a project, training a fault pattern based on the collected fault data, in response to a fault occurring in a latest version of the project, extracting a first suspicion value for each of statements included in the latest version of the project, based on a baseline fault localization method, obtaining a latest crossword corresponding to the latest version of the project, based on the trained fault pattern and a fault type of the latest version of the project, and updating the first suspicion value to a second suspicion value based on the latest crossword and the first suspicion value.

### CROSS-REFERENCE TO RELATED APPLICATIONS

This application claims the benefit under 35 USC § 119(a) of Korean Patent Application No. 10-2024-0082970, filed on Jun. 25, 2024, in the Korean Intellectual Property Office, the entire disclosure of which is incorporated herein by reference for all purposes.

### BACKGROUND

### 1. Field

The following description relates to a method and apparatus with fault localization.

### 2. Description of Related Art

Project fault localization may shorten the development time and increase software stability during development of a project. Conventional fault localization methods may estimate the location of a fault by analyzing an execution path of code, an error message, and user feedback. In general, the methods are universally applied to all projects and may not significantly consider a specific characteristic or a past fault history of a project.

When a characteristic of a project is not considered, a problem may arise because each project has different code and project-specific problems. For example, a certain type of error that appears repeatedly in a certain project may be difficult to identify effectively with a universal analysis tool. Previous project fault localization methods fail to understand unique characteristics of a project and diagnose a fault based on this understanding.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fault localization method performed by one or more processors includes collecting fault data from past versions of a project that is a target of the fault localization method, training a fault pattern based on the collected fault data, based on a fault in a latest version of the project, extracting/generating, by applying a baseline fault localization method to the latest version of the project, first suspicion values of respective statements included in the latest version of the project, obtaining the latest crossword corresponding to the latest version of the project, based on the trained fault pattern and a fault type of the latest version of the project, and updating the first suspicion values to respective second suspicion values based on the latest crossword and the first suspicion values.

The training of the fault pattern may include obtaining past crosswords respectively corresponding the past versions of the project, based on a crossword training algorithm.

The crossword training algorithm may be an algorithm configured to generate an initial crossword, obtain sets of tokens for each of the past versions of the project, variously mutate the initial crossword for each of the sets of tokens to measure performance of the mutated initial crossword, and train a crossword for each of the past versions of the project, based on the measured performance of the mutated initial crossword.

The obtaining of the latest crossword corresponding to the latest version of the project may include extracting at least one candidate crossword from among the past crosswords by considering a version context between the latest version of the project and the past versions of the project

The extracting of the at least one candidate crossword may include selecting the at least one candidate crossword based on a similarity between a token extracted from the past versions of the project and a token extracted from the latest version of the project.

The method may further include generating the latest crossword by synthesizing the at least one candidate crossword, based on the number of the at least one candidate crossword being greater than or equal to 2.

The method may further include generating an indentation tree from the project and obtaining the latest crossword based on the indentation tree.

The latest crossword may be a suspicion transformation function that maps a token and a suspicion value to each of corresponding nodes in the latest crossword.

The method may further include updating the latest crossword based on a crossword update algorithm, based on a user input indicating a fault correction for the latest version of the project.

The method may further include training the latest crossword based on a fault localization training algorithm.

In another general aspect, an electronic device includes one or more processors and a memory storing instructions configured to cause the one or more processors to: collect fault data from past versions of a project that is a target of fault localization; train a fault pattern based on the collected fault data; based on a fault in a latest version of the project, generate, by applying a baseline fault localization method to the latest version of the project, generate first suspicion values of respective statements included in the latest version of the project; based on a baseline fault localization method, obtain the latest crossword corresponding to the latest version of the project, based on the trained fault pattern and a fault type of the latest version of the project; and update the first suspicion values to respective second suspicion values based on the latest crossword and the first suspicion value.

The one or more processors may be configured to obtain past crosswords respectively corresponding to the past versions of the project, based on a crossword training algorithm.

The one or more processors may perform an algorithm that generates an initial crossword, obtains sets of tokens for each of the past versions of the project, variously mutates the initial crossword for each of the sets of tokens to measure performance of the mutated initial crossword, and trains a crossword for each of the past versions of the project, based on the measured performance of the mutated initial crossword.

The one or more processors may be configured to extract at least one candidate crossword from among the past crosswords by considering a version context between the latest version of the project and the past versions of the project.

The one or more processors may be configured to select the at least one candidate crossword based on a similarity between a token extracted from the past versions of the project and a token extracted from the latest version of the project.

The one or more processors may be configured to generate the latest crossword by synthesizing the at least one candidate crossword, in response to the number of the at least one candidate crossword being greater than or equal to 2.

The one or more processors may be configured to convert the project into an indentation tree form based on a predetermined method.

The latest crossword may be a suspicion transformation function that maps a token and a suspicion value to each of nodes.

The one or more processors may be configured to update the latest crossword based on a crossword update algorithm, in response to receiving, from a user, a fault correction input for the latest version of the project.

The one or more processors may be configured to train the latest crossword based on a fault localization training algorithm.

Other features and aspects will be apparent from the following detailed description, the drawings, and the claims.

### BRIEF DESCRIPTION OF THE DRAWINGS

FIG. 1 illustrates an example of a baseline fault localization method, according to one or more embodiments.

FIG. 2A illustrates an example of a fault localization method, according to one or more embodiments.

FIG. 2B illustrates an example of a crossword, according to one or more embodiments.

FIG. 3 illustrates an example of a fault localization method, according to one or more embodiments.

FIGS. 4A to 4D illustrate examples of a crossword training algorithm, according to one or more embodiments.

FIG. 5 illustrates an example of a crossword, according to one or more embodiments.

FIG. 6 illustrates an example of a fault localization method including project-aware fault localization (PAFL), according to one or more embodiments.

FIGS. 7A and 7B illustrate examples of a fault localization algorithm, according to one or more embodiments.

FIGS. 8A and 8B illustrate examples of a fault localization training algorithm, according to one or more embodiments.

FIGS. 9A and 9B illustrate examples of a crossword update algorithm, according to one or more embodiments.

FIG. 10 illustrates an example of an electronic device, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Previous methods of fault localization (e.g., finding a line or module where a fault occurred) often fail to solve difficulties unique to a target project. Prior fault localization methods may fall short because they attempt to localize a fault using a general strategy that fails to take into account project-specific difficulties or faults. Embodiments and examples described herein may employ project-aware fault localization (PAFL), which is a fault localization method that can overcome version-agnostic limitations of previous fault localization methods.

PAFL may provide version-sensitive localization by training fault patterns (e.g., lexical/syntactic patterns) in past versions of a target project and then using the fault patterns of past versions to determines, when an error occurs in the latest version of the target project, whether the is similar to past versions of the target project. The suspectability of each statement calculated using the fault localization method according to the related art.

PAFL may be a post-processing method that updates the initial suspectabilities (metric/probability of being a fault cause) of statements calculated using a baseline fault localization method when each statement in statements of a project belongs to a fault pattern that appeared in the past version of the project.

PAFL may use a crossword, which is a domain-specific language and a suspicion-specific transformation function, to describe various fault patterns and the impact of the various fault patterns on the suspiciousness. The crossword may describe the way a suspicious statement is updated when a fault pattern and a corresponding statement belong to the fault pattern.

PAFL may include an algorithm that synthesizes crosswords in the past version of a target project. A trained crossword may be used to update the suspiciousness of a statement in the latest version of the target project.

Hereinafter, a project described in the examples may be a software program including a series of pieces of code. The series of pieces of code may include a series of command statements in the form of sentences. Accordingly, in the descriptions below, the term “statement” may refer to a line that forms code.

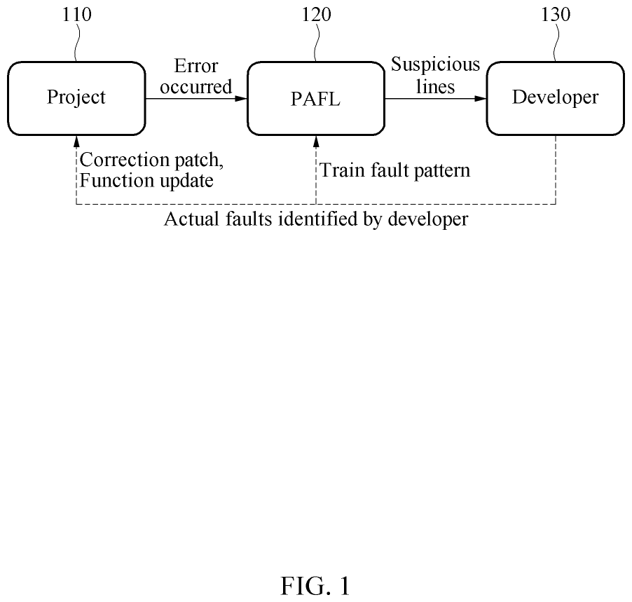

FIG. 1 illustrates an example of a baseline fault localization method, according to one or more embodiments.

The blocks and steps shown in FIG. 1 may be implemented by a special-purpose hardware-based computer that performs a predetermined function and/or by computer instructions and general-purpose hardware. The description herein, including equations, may be used as a blueprint to construct source code that may be compiled with known software engineering tools to produce executable instructions that will cause a computing device (one or more processors) to operate analogously to the description herein. The mathematical descriptions and equations herein are not the direct object of this disclosure, rather, they are a convenient language for concisely describing programming source code, machine instructions, or the like, and the operations of computing machinery according to the same.

Referring to FIG. 1, a processor 1030 may perform development on a project 110 using a PAFL module 120 included as part of a larger (baseline) fault localization method. When an error occurs while a user 130 is developing the project 110, the processor 1030 may localize a fault (e.g., identify a line/statement of the fault) using a fault pattern trained in the past version of the project 110, using the PAFL module 120, which has instructions configured for fault localization. When the user 130 identifies an actual fault and updates the project by correcting the fault, the processor 1030 may train the fault pattern by applying a crossword to a newly discovered fault and updating PAFL through this process. Subsequently, when the user 130 updates the latest project 110 again and the processor 1030 finds a similar error, the processor 1030 may localize the fault using the trained fault pattern (fault information of past version(s) may be extended to the present version).

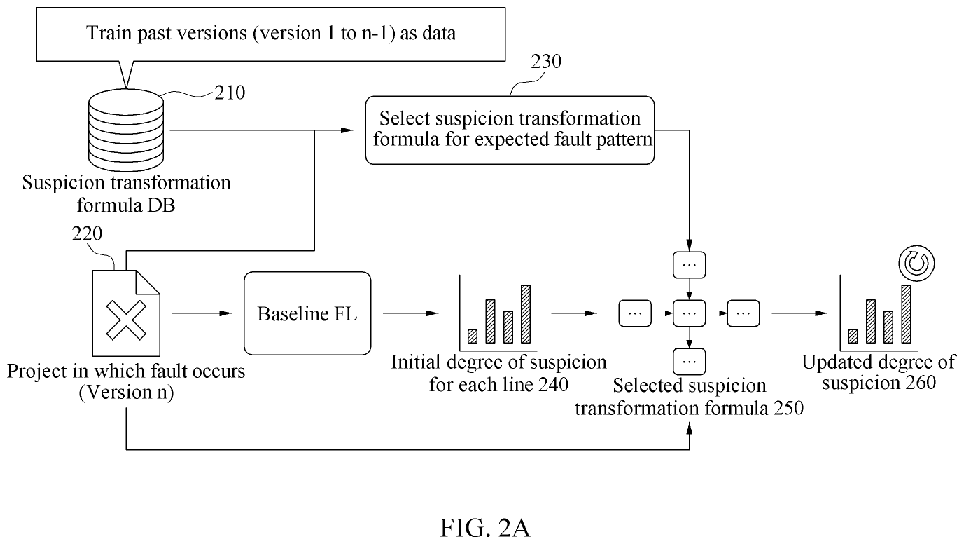

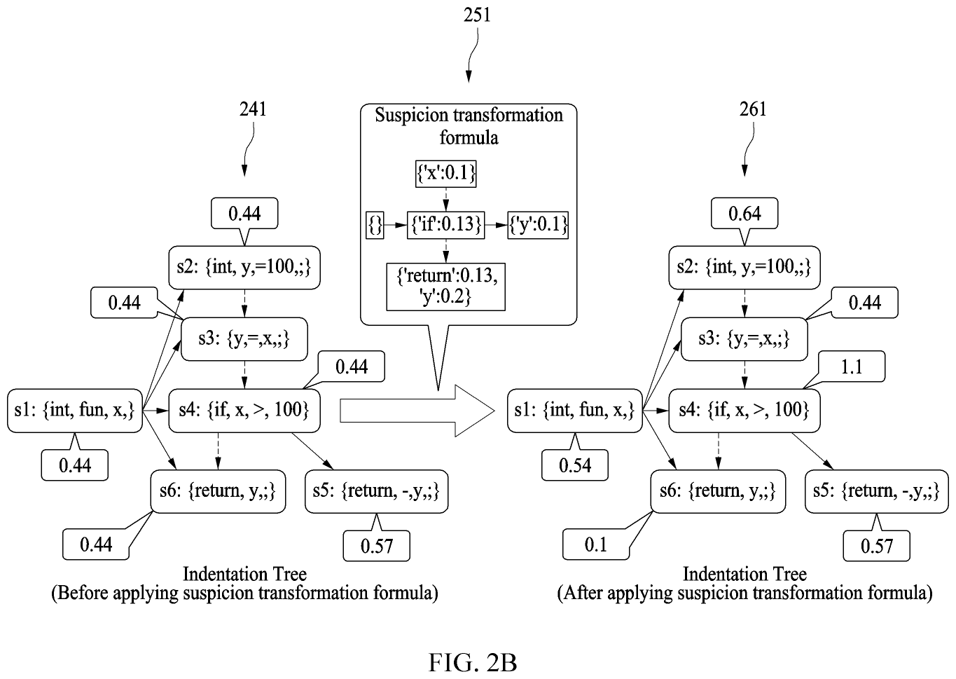

FIG. 2A illustrates an example of a fault localization method, according to one or more embodiments. The fault may also be referred to as a target fault.

Referring to FIG. 2A, the processor 1030 may localize a fault occurring in the latest version of a project by using a fault pattern trained in the past version(s) of the project.

The processor 1030 may access a suspicion transformation formula database (DB) 210 containing data that trains fault data in past versions (version 1 to version n-1) of the project. When a fault occurs in a latest version 220 (version n) of the project, the processor 1030 may extract/generate values of initial degrees of suspicion for respective lines 240 (e.g., source code lines/statements of the project) using a baseline fault localizer (FL). In addition, the processor 1030 may, concurrent with the obtaining of the suspicion degrees of the respective lines 240, perform operation 230 of extracting/generating a suspicion transformation formula (or a crossword) 250 having a fault pattern that is similar to the target fault (which is in the latest version 220 of the project). The processor 1030 may then update the initial degrees of suspicion of the respective lines 240 using the suspicion transformation formula (or the crossword) 250 corresponding to the latest version 220 of the project. A degrees of suspectability/suspicion (e.g., scores, ratings, probabilities, etc.) is also referred to herein as a “suspectability” or a “suspicion”. The user may determine which of the statements the fault occurred in based on updated degrees of suspicion 260.

When the PAFL module is executed, the processor 1030 may consider two contexts of the fault. First, a version context of the fault may be considered, and second, a code context of the fault may be considered, both to accurately localize the fault.

First, when the PAFL module is executed, in a stage of identifying the version context, the processor 1030 may determine whether a similar error occurred in a past version of the project. When it is determined that a similar error occurred, the processor 1030 may execute a crossword selection algorithm and return a fault pattern that is a crossword trained in the past version(s) of the project. After the crossword is selected, the processor 1030 may execute a fault localization algorithm and determine the initial suspicious metric in each statement included in the project. Subsequently, when there is a statement belonging to (matching) a fault code pattern (e.g., a pattern of one or more tokens) identified by the selected crossword, the processor 1030 may increase the suspectability of the statement. When this suspectability updating is finished, based on the updated suspectabilities, the fault localization algorithm may identify a statement with high suspectability (e.g., above a threshold, top-k highest, etc.) as localized fault(s).

FIG. 2B illustrates an example of a crossword, according to one or more embodiments.

Referring to FIG. 2B, initial degrees of suspicion 241 are examples representative any of the initial degrees of suspicion of the lines 240 of FIG. 2A (the specific numbers/parameters of the example suspicion are non-limiting examples). The suspicion transformation formula 251 shown in FIG. 2B is a non-limiting example of the suspicion transformation formula 250 of FIG. 2A. Updated degrees of suspicion 261 are examples of the updated degrees of suspicion 260 of FIG. 2A. Referring to the example initial degrees of suspicion 241, the suspicion values of statements s1, s2, s3, and s4 are 0.44 and the suspicion value of statement s5 is 0.57. Accordingly, it may be difficult for the user to easily discern which of the statements is to be suspected of being the origin of the target fault. However, the updated degrees of suspicion 261 may be obtained by applying the suspicion transformation formula 251. The suspicion transformation formula 251 may have grammatical rules and associated adjustment values. The suspicion transformation formula 251 may be applied to each of the statements s1 to s5. For example, when a target statement is the statement s4, applying the suspicion transformation formula 251 to the statement s4, because the statement s4 has an “if” matched to a rule in the suspicion transformation formula 251, the statement s3 above the statement s4 includes a matching “x,” the statement s5 right to the statement s4 includes a matching “y,” and a statement s6 below the statement s4 includes a matching “return” and “y,” the degree of suspicion of the statement s4 may increase by summing the adjustment amounts respectively associated with the matching grammatical components, i.e., 0.13+0.1+0.1+0.13+0.2=0.66, which is added to statement s4's initial suspicion of 0.44, resulting in it having an updated total degree of suspicion of 1.1. Accordingly, the statement s4 may have a suspicion value of 1.1, so the user may identify the statement s4 as a statement suspected of having a fault. Of course, the suspicion value may be used by an automated tool such as a debugger, code analysis tool, or the like.

As can be seen in FIG. 2B, an indentation tree, or suitable structure, may be used to represent the grammatical structure of the relevant code of the target project. The example shown in FIG. 2B may be an entire program, a section of code of interest, etc. The suspicion transformation formula may be systematically applied to the grammar components of the indentation tree by walking the tree and applying (e.g., pattern matching) one or more of the rules of the formula to a current part of the tree being walked.

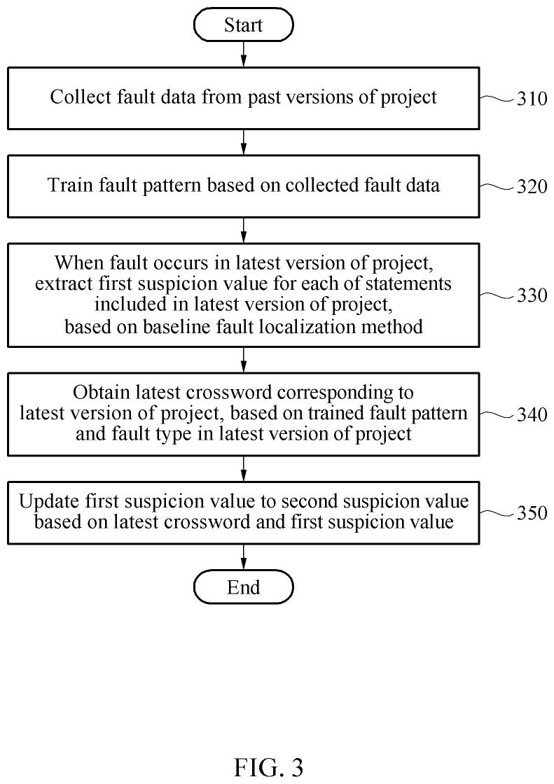

FIG. 3 illustrates an example of a fault localization method, according to one or more embodiments.

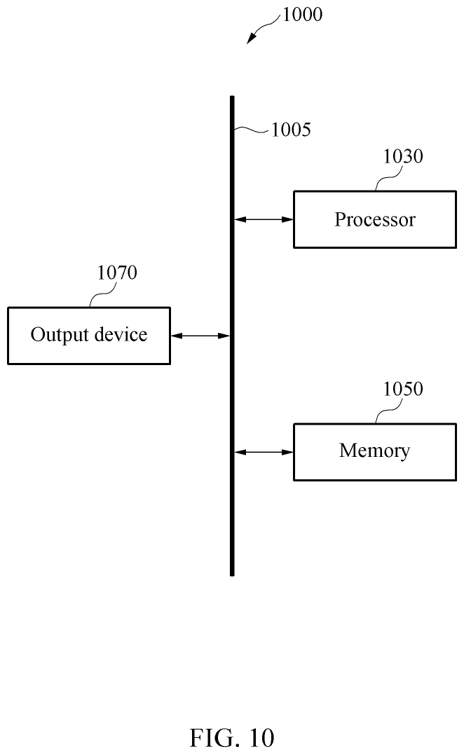

For ease of description, operations 310 to 350 are described as being performed by an electronic device 1000 illustrated in FIG. 10. However, operations 310 to 350 may be performed by another suitable electronic device in a suitable system.

In operation 310, the processor 1030 may collect fault data from past versions of a project.

In operation 320, the processor 1030 may train a fault pattern based on the collected fault data (described in detail later). The processor 1030 may obtain past crosswords corresponding to each of the past versions of the project, based on a crossword training algorithm.

The crossword training algorithm may be an algorithm that generates an initial crossword, obtains sets of tokens for each of the past versions of the project, variously mutates the initial crossword for each of the sets of tokens to measure the performance of the mutated initial crossword, and trains a crossword for each of the past versions of the project, based on the measured performance of the mutated initial crossword.

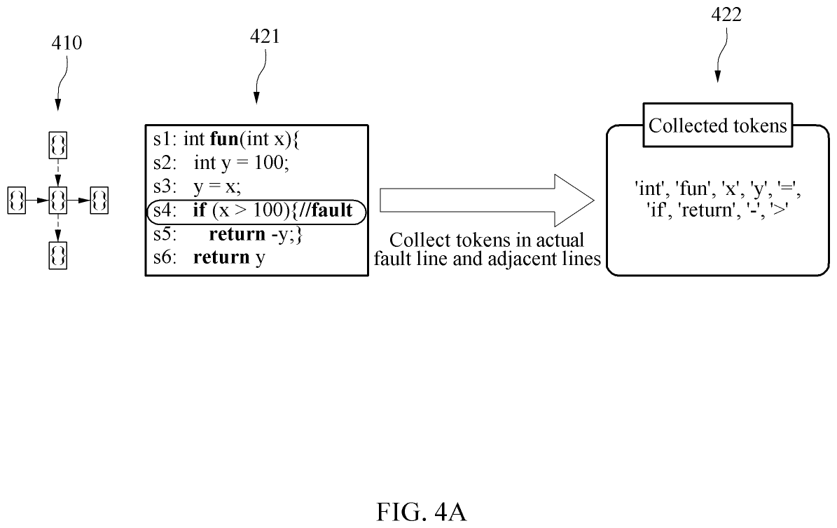

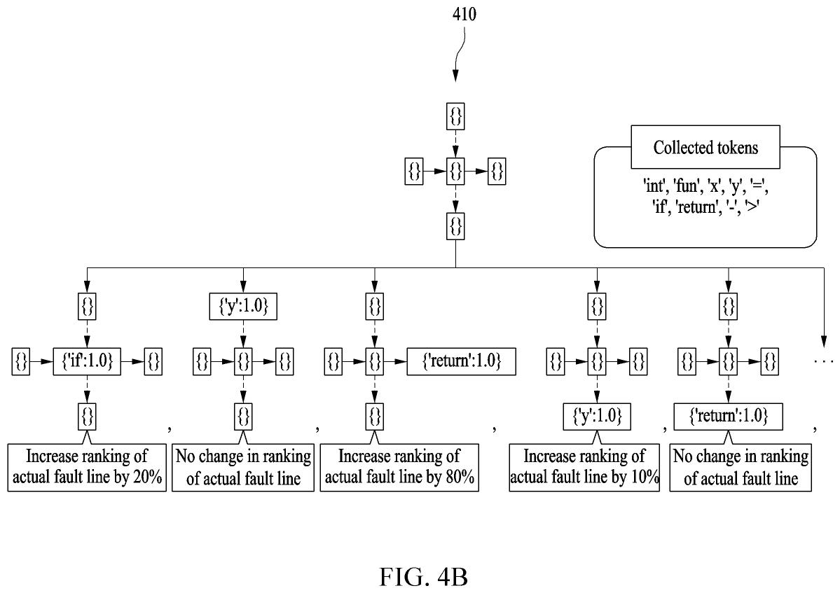

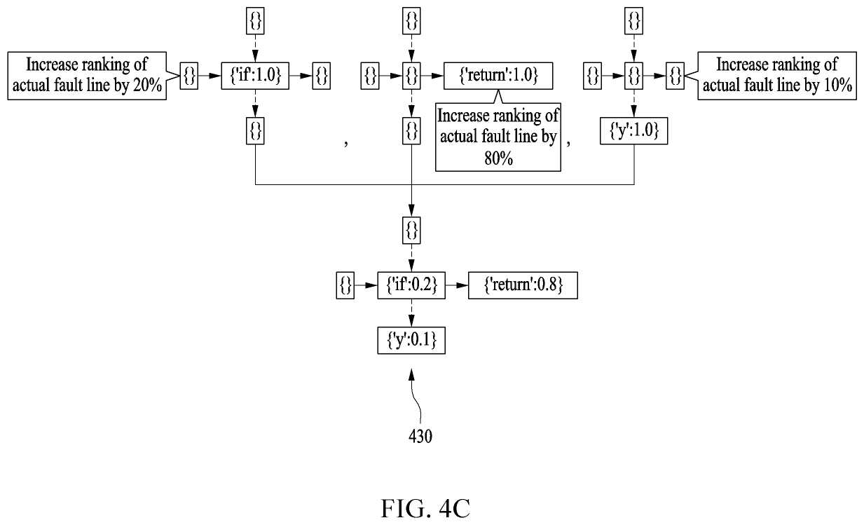

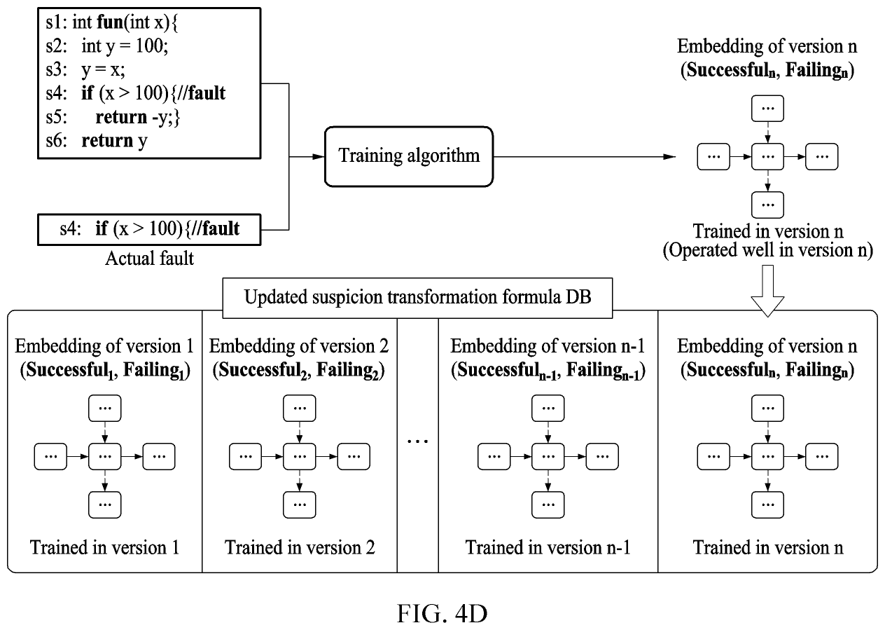

The crossword training algorithm is described in detail below with reference to FIGS. 4A to 4D.

In operation 330, when a fault occurs in the latest version of the project, the processor 1030 may extract a first suspicion value for each of statements included in the latest version of the project, based on a baseline fault localization method. The baseline fault localization method may be any algorithm that estimates fault likelihood based on inherent traits of the source code of the latest version of the project, for example, based on general statistics of code constructs, based on complexity analysis, or the like (a specific example is described below).

In operation 340, the processor 1030 may obtain the latest crossword corresponding to the latest version of the project, based on the trained fault pattern and a fault type in the latest version of the project. The processor 1030 may extract one or more candidate crosswords from among the past crosswords by considering a version context between the latest version of the project and the past versions of the project. The processor 1030 may select the candidate crossword(s) based on a similarity (or pattern match) between a token extracted from the past versions of the project and a token extracted from the latest version of the project. When multiple candidate crosswords are extracted, the processor 1030 may generate the latest crossword by synthesizing the candidate crosswords.

The latest crossword may be a suspicion transformation function (or a suspicion transformation formula) that maps tokens and to suspicion values of respective nodes in a tree of tokens.

In operation 350, the processor 1030 may update the first suspicion value to a second suspicion value based on the latest crossword and the first suspicion value.

The processor 1030 may convert source code of the project into an indentation tree form based on a predetermined method, for example by parsing the source code and applying lexical and grammatical analysis tools to the source code.

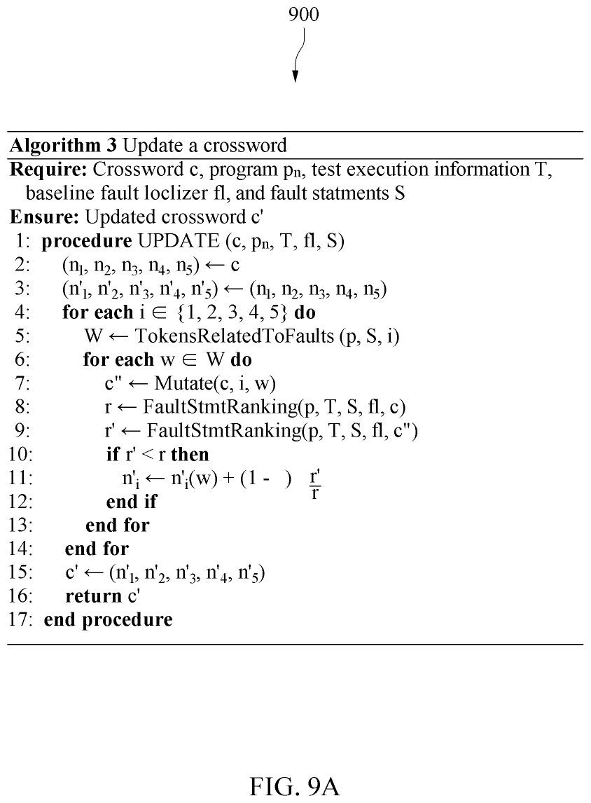

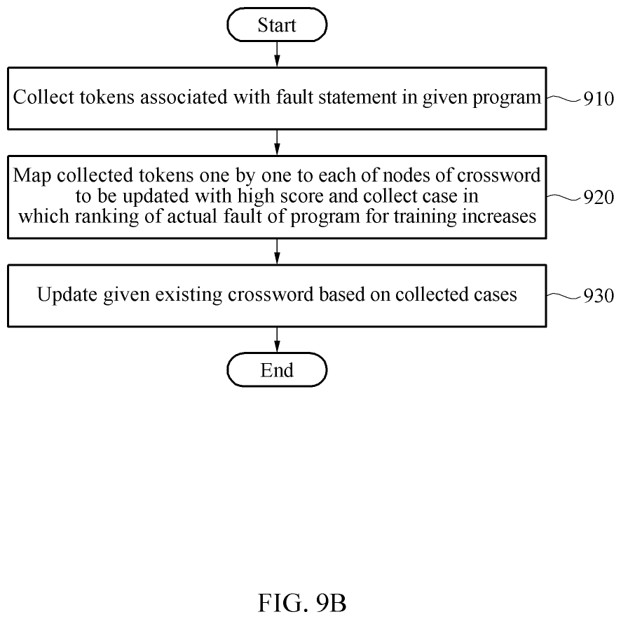

When a fault correction input (e.g., a location, version, or module of a fault) for the latest version of the project is received from the user, the processor 1030 may update the latest crossword based on a crossword update algorithm. The crossword update algorithm is described in detail below with reference to FIG. 9.

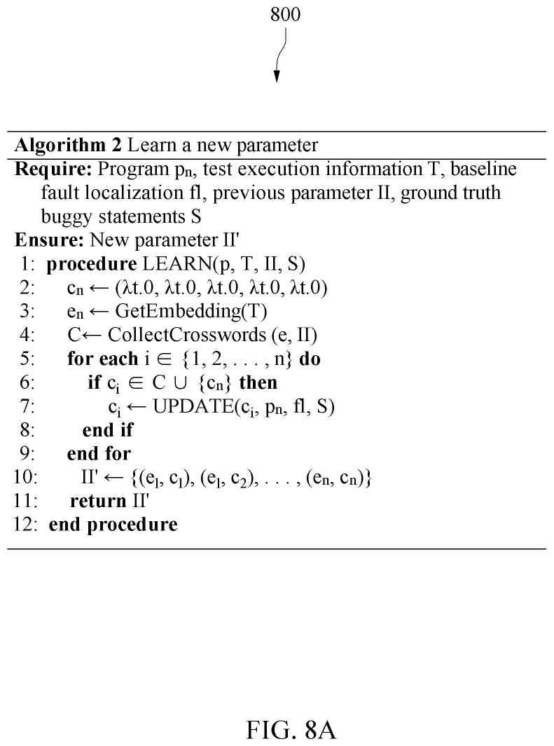

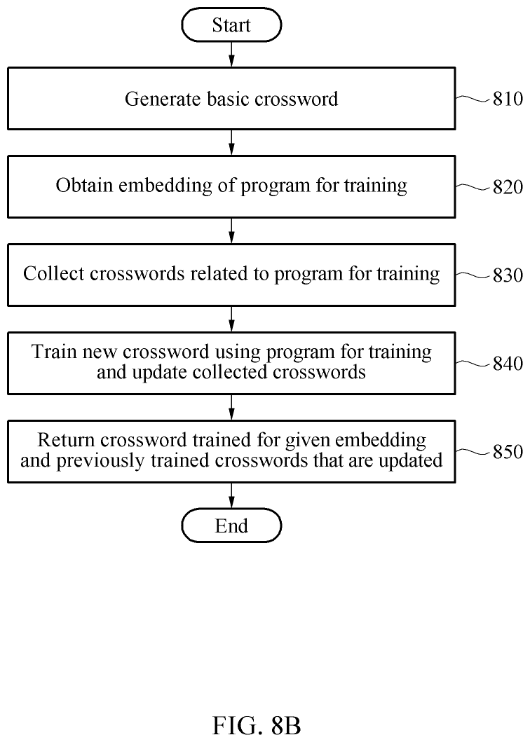

The processor 1030 may train the latest crossword based on a fault localization training algorithm. The fault localization training algorithm is described in detail below with reference to FIG. 8.

FIGS. 4A to 4D illustrate examples of a crossword training algorithm, according to one or more embodiments.

Referring to FIG. 4A, the processor 1030 may generate an initial crossword (or a suspicion transformation formula) 410. The initial crossword may be a blank template defining a structure of token interrelationships. In addition, the processor 1030 may obtain collected tokens 422 by collecting tokens in an actual fault line and adjacent/nearby lines in a project 421 in which a fault occurs. Here, “token” has the usual meaning in lexical analysis of programming code and may refer to a word, a symbol, a number, etc., included in statements of a project. In the described examples, words and symbols are collected as tokens, but the definition of “token” is not limited to the described examples.

Referring to FIG. 4B, the processor 1030 may form various mutations of the initial crossword 410 using the collected tokens 422 and measure the performance of the mutations. As shown in FIG. 4B, the processor 1030 may insert the collected tokens 422 into each of nodes of the initial crossword 410 and determine their respective effects (e.g., how much the increase the suspicion value of the actual fault line). For example, if a mutation increases ranking by 20%, 0.2 may be saved in association with that mutation. The processor 1030 may verify that the mutation of the initial crossword 410 obtained by the inserted collected tokens 422 ultimately increases a suspicion value of an actual fault line. In addition, the processor 1030 may verify the performance of the mutated initial crossword 410 by verifying whether the mutated initial crossword 410 is mutated in a direction that increases the suspicion ranking of the actual fault line.

Referring to FIG. 4C, the processor 1030 may generate a final crossword 430 by merging the mutated crosswords whose performance has been identified in the process of mutating the initial crossword 410 described above. That is, the mutated crosswords whose performance is identified as sufficient may be, in the example, a token ‘if’ inserted into the central node, a token ‘return’ inserted into the right node, and a token ‘y’ inserted into the lower node, and accordingly, the processor 1030 may determine a suspicion-increase value based on the increase rate of the ranking.

Referring to FIG. 4D, the processor 1030 may schematically identify crosswords trained in the past versions of the project. The processor 1030 may perform a process of generating the final crossword 430 from the initial crossword 410 described above on all the past versions of the project, and finally, the processor 1030 may generate a crossword for a fault in the latest project (version n) and store the crossword in the DB. The crosswords may be stored in association with their corresponding versions.

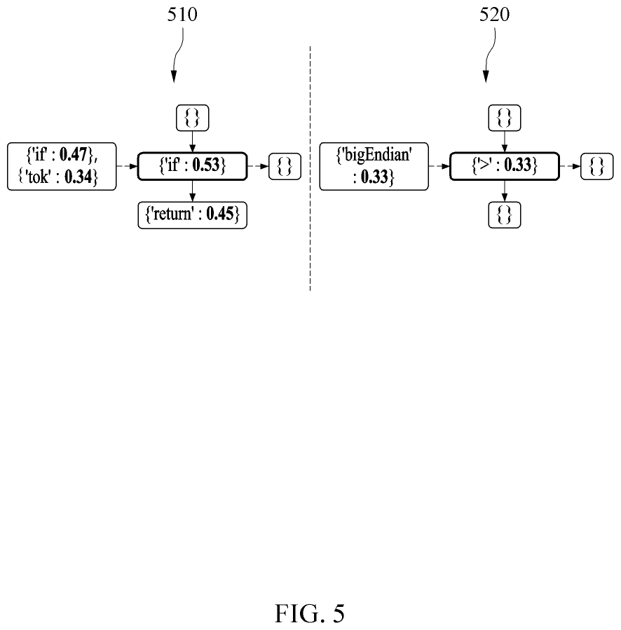

FIG. 5 illustrates an example of a crossword, according to one or more embodiments.

Referring to FIG. 5, a first crossword 510 and a second crossword 520 may be crosswords trained in respective past versions of a project. The first crossword 510 and the second crossword 520 may be used to increase the degree of suspicion in a fault localization method when projects are updated to new versions.

Referring to FIG. 5, the first crossword 510 may be a crossword used in the existing fault localization technique. A crossword is a graph having nodes (e.g., five nodes), and each node represents a fault pattern (e.g., pattern of one or more tokens) appearing in the project (the crossword is a pattern of tokens with fault likelihood information). In the first crossword 510, a first central node represents a pattern of a fault statement (e.g., a statement matching the central node may be considered to be the fault statement), and the other four nodes describe a pattern of adjacent statements. The right-pointing arrow expresses a sequential relationship between pattern-represented statements, and the downward-pointing arrow expresses a branch relationship between pattern-represented statements.

For example, in the cross-shaped structure of nodes representing the first crossword 510, the first central node includes a suspicion value (0.53) for a token ‘if,’ a first left node includes suspicion values (0.47 and 0.34) for the tokens ‘if’ and ‘tok’, respectively, and a first bottom node includes a suspicion value (0.45) for a token ‘return.’ When the crossword is compared to (evaluated against) a target statement, the first central node's content of “{‘if’: 0.53}” indicates that if the target statement includes ‘if’ then the degree of suspicion increases by 0.53. The first bottom node's content of “{‘return’: 0.45}” indicates that the degree of suspicion of the target statement increases by 0.45 when the token ‘return’ is included in a statement that has a branch relationship with the target statement. The first left node's content of “{‘if’: 0.47, ‘tok’: 0.34}” indicates that the degree of suspicion of the target statement (i) increases by 0.47 when a previous statement of the target statement includes the token ‘if’, or (ii) increases by 0.34 when the token ‘tok’ is included in the previous statement of the target statement.

For example, assuming that (i) a target statement is “if (expr && !precedes( . . . )),” (ii) the statement to the target statement includes the token ‘if,’ and (iii) a statement in the lower branch relationship thereof includes the token ‘return,’ the degree of suspicion of the target statement may be the sum of the suspicions of the respective matching crossword nodes, i.e., 0.53+0.47+0.45=1.45.

Likewise, in the cross-shaped structure of nodes representing the second crossword 520, a second central node includes a suspicion value for a token ‘>,’ and a second left node includes a suspicion value for a token ‘bigEndian.’ Accordingly, when a target statement includes the token ‘>’ and the previous statement of the target statement includes the token ‘bigEndian,’ the degree of suspicion of the target statement may be 0.33+0.33=0.66.

To effectively localize a fault in a PAFL module, a crossword that accurately considers a version context and accurately describes a code context may be employed.

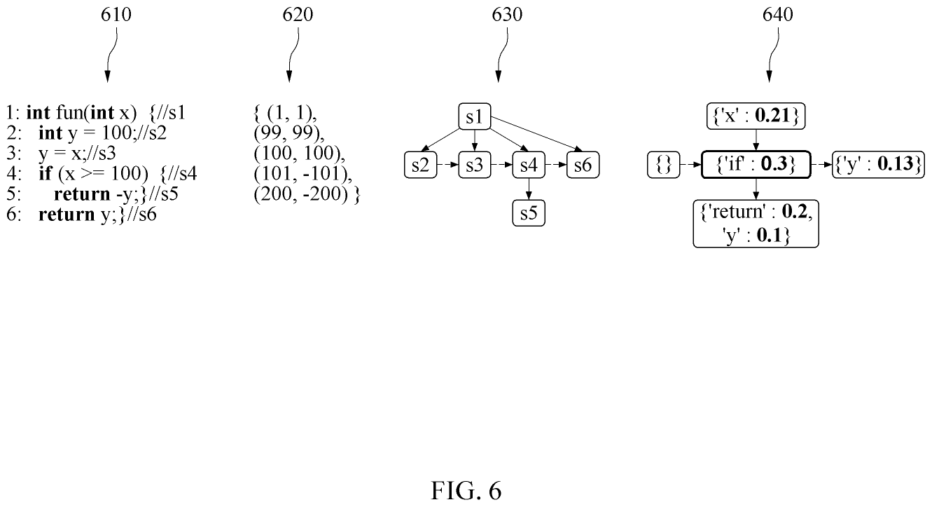

FIG. 6 illustrates an example of a fault localization method including a PAFL technique, according to one or more embodiments.

Referring to FIG. 6, example code 610 is an example program (or project) including a fault in statement 4 (s4), for example, as uncovered by a test run. A set of test cases 620 represent input-output pairs that the example program must satisfy. For example, a first test case (1,1) indicates that the program should return 1 when an input is 1. When the example code 610 is executed for a third test case (100, 100), 100 is inputted and if −100 is outputted then the third test case is not satisfied (a fault occurs). Based on the fault, it might be determined that a token ‘>=’ in the fault statement 4 needs to be updated to a token ‘>.’ Further regarding the fault of the −100 output, considering example code 610 in comparison to test cases 620, when 100 is inputted to program, the −100 is outputted based on statement 4 (s4), which results in an error relative to the expected output indicated in the test cases 620. Therefore, it can be determined that statement 4 (s4) needs to be corrected from “>=” to “>” (so that 100 is output correctly when 100 is input). Since statement 3 (s3) is not an erroneous statement it does not require a change.

When the PAFL module is executed, the processor 1030 may input, to the PAFL module (e.g., as input parameters to the module), (i) the program, (ii) a statement Stmt in the program (a return value indicating the statement determined to have the highest adjusted suspicion scoring/ranking), (iii) a test execution result set 2^{TestInfo} (test data), (iv) a baseline FL, and (v) a trained context (parameter) set 2^{Context}. These parameters to the PAFL module are described in turn next. Based on these inputs, PAFL may output a suspicious metric of given code, as shown in Equation 1 below.

$$PAFL : Program \times Stmt \times {2}^{TestInfo} \times FL \times {2}^{Context} \to ℝ \qquad Equation 1$$

Regarding input parameter (i), thein inputted, program (p∈Program) may be defined as a sequence (Program=Stmt*) of statements. Here, the statements may be a sequence of pairs of the form (Stmt=N×Token*, Token=Char*) of respective line numbers (e.g., labels of the statements) and respective lexical tokens. The “*” in Stmt* indicates that 0 or more Stmt are consecutively listed (e.g., Stmt*={ϵ, Stmt, Stmt Stmt, Stmt Stmt Stmt, . . . }). A program p may be considered as a series of statements and may thus be defined as a sequence of statements.

For example, the program p may be a series of three statements (program=<S1, S2, S3>), as shown below.

| 0: main( ){ | // First statement S1 |
|---|---|
| 1: print(“hello world!”); | // Second statement S2 |
| 2: } | // Third statement S3 |

The statements described above may be expressed as a series of respective line numbers N and associated tokens Token*, as shown below.

0: main( ){ → ( 0, < main, (, ), {>)
1: print(“hello world!”){ → ( 1, < \t, print, (, “hello world!”, ), ;>)
2: } → ( 2, < }>)

Each statement number indicates that each line of a program is a different statement. The PAFL module may use the tokens in each line/statement of the inputted program to update their respective suspicion scores using a crossword.

For example, the program (p∈Program) of the example source code 610 may be a sequence of six statements <s1, s2, s3, s4, s5, s6>, the tokenization of which is shown in Equation 2 below (the underscore symbol representing whitespace and the \t symbol representing a tab or indentation).

$$s 1 = ( 1 , int , , main , ( , int , , x , ) , \{ ) \qquad Equation 2$$

$$s 2 = ( 2 , \backslash t , int , , y , , = , , 100 , ; )$$

$$s 3 = ( 3 , \backslash t , y , , = , , x , ; )$$

$$s 4 = ( 4 , \backslash t , if , , ( , x , , >= , , 100 , ) \{ )$$

$$s 5 = ( 5 , \backslash t , \backslash t , return , , - , y , ; , \} )$$

$$s 6 = ( 6 , \backslash t , return , , y , ; , \} )$$

Regarding input parameter (iii) mentioned above, in the test case execution result set inputted to the PAFL module, each individual execution result indicates which statements were executed and whether the test result passed or failed. Equation 3 formally describes the test case execution result set.

$$TestInfo = {2}^{Stmt} \times \{ pass , fail \} \qquad Equation 3$$

For example, the test execution result (T∈TestInfo) of the first test case (1, 1) for the program of the example code 610 may be ({s1, s2, s3, s4, s6}, pass) (the omission of s5 indicating that statement s5 was not executed, and “pass” indicating that the expected output of 1 was returned when the first test case was run).

The test case execution results of five test cases ({(1,1), (99,99), (100,100), (101,−101), (200,−200)} may be {({s1, s2, s3, s4, s6}, pass), ({s1, s2, s3, s4, s6}, pass), ({s1, s2, s3, s4, s5}, fail), ({s1, s2, s3, s4, s5}, pass), and ({s1, s2, s3, s4, s5}, pass)}, respectively. The set of execution results may be produced by a test system applying the current version of the program to the test cases.

Regarding the input parameter (iv) mentioned above, the baseline fault localization method (fl∈FL) inputted as a parameter to the PAFL module may be used by, the processor 1030 to calculate the initial/baseline degree of suspicion of each statement stmt∈Stmt of the inputted program. For example, in an example where the fl method is a spectrum-based fault localization method, the fl method may calculate the degree of suspicion of each statement by applying the following Equation 4, using the test case execution results set (T∈TestInfo) input parameter (received by the PAFM module).

$$Suspiciousness ( Ochiai ) = \frac{{N}_{CF}}{\sqrt{{N}_{F} \times ( {N}_{CF} + {N}_{CS} )}} \qquad Equation 4$$

In Equation 4, for suspiciousness of a given statement, N_{CF} denotes the number of failing test cases passing through (executing) the given program line/statement, N_{CS} denotes the number of successful test cases passing through (executing) the given program line/statement, and N_{F} denotes the total number of failed test cases. In short, suspiciousness of a line/statement may be a ratio of its test fails relative to its test successes and the total test fails, for example. Any other metric for measuring or predicting likelihood of a line being responsible for a fault may be used.

After calculating the default/baseline localized suspicion score for each line/statement using Equation 4, a line/statement having a high baseline suspicion score may be estimated as a fault line/statement that causes an error. In the example set of test results, the baseline suspicion value of the statement s4 may be calculated as

$$\frac{1}{\sqrt{1 + 4}} \approx 0.44 .$$

Regarding the input parameter (v) mentioned above, for the set of trained contexts inputted to the PAFL module, the PAFL module may update the suspicions of this inputted set of contexts that has been trained in the past version of a project and may do so after the baseline FL generates the initial suspicions for the respective statements. The trained contexts may be a crossword (for considering a code context) pair (Context=ErrorEmbedding×CrossWord) corresponding to error embedding (for considering a version context) and a fault code pattern. The error embedding and crossword may each refer to the fault code pattern associated with a fault pattern in the past version of the project. A fault localization algorithm may collect and use crosswords (which have been trained in the past version of the project) whose error embeddings are similar to the error embedding of the current version of the project.

An error embedding may be a map from each token to a pair which is (i) the number of passes and (ii) the number of fails of the corresponding token in test case 620 including a corresponding token in each token (ErrorEmbedding=Token→ [symbol] ×Token→ [symbol] ) for. When a token included in a given test case result (i.e., included in the statement list associated with that test care result) appears in multiple statements of the given test case result, that token may be calculated each time it appears in a statement of the given test result (recall that a given test result associated with a given test case (input-output) may include, for a run of the given test case, a list of activated/executed statements and for the test run and a pass/fail indication for the test run). Among test runs of the test cases 620, for description, it may be assumed that only the third test case fails, and (mₚₐₛₛ, m_{fail})∈ErrorEmbedding, which includes five statements s1, s2, s3, s4, and s5 (as per the example of Equation 2), is the error embedding. For a given test case execution result set, its associated error embedding may map each token in the given test case execution result set to (i) the number of times any statement encompassing the token was executed in association with a pass (mₚₐₛₛ), and (ii) the number of times any statement encompassing that token was executed in association with a fail (m_{fail}). In other words, the embeddings associated with a given test case execution result set may be statistics about how often different tokens were associated with a pass and how often they were associated with a fail. Referring to the example, since the failing test case includes a token ‘−’ in the statement s5, m_{fail}(‘−’) may be 1 (i.e., m_{fail}(‘−’)=1), and since the failing test case includes a token ‘y’ in the statements s2, s3, and s5, m_{fail}(‘y’) may be 3 (i.e., m_{fail}(‘y’)=3). For ease of description, a get-embedding function may be defined as GetEmbedding: 2TestInfo→ErrorEmbedding, i.e., a function that returns the error embedding for a given test case execution result set.

Computation of the return-value parameter (ii) mentioned above (i.e., the statement returned from as the first/final fault-suspicious statement), determination of the returned statement is described next.

An indentation tree 630 may be a simple tree-type expression/structure that describes syntactic relationships (tree links) between statements (tree nodes). In the indentation tree 630, each node may refer to a statement of a program. The downward-pointing arrows represent a branch relationship (e.g., different indentations, blocks, etc.) between nodes. For example, as per the example of Equation 2, the statement s4=(4, [symbol] \t, if, ␣, (, x, ␣, >=, ␣, 100,){ [symbol] ) may be a branch statement of the statement s1, and the statement s5 may be a branch statement of the statement s4. The right-pointing arrow may represent a sequential relationship (e.g., the same indentation) between nodes. For example, the statements s3 and s6 may have a sequential relationship with the statement s4. The indentation tree 630 may be used to form crosswords for updating the degrees of suspicion of respectively corresponding statements in the inputted program.

In an example implementation, a crossword (c∈CrossWord) 640 may include five nodes, as shown in Equation 5 below (other structures or node numbers may be used).

$$CrossWord = Node \times Node \times Node \times Node \times Node \qquad Equation 5$$

However, the crossword 640 may not necessarily include five nodes and may also include six or more nodes, or for or fewer nodes. For example,
Crossword′=Node×Node×Node×Node×Node×Node; the number of nodes in the crossword 640 is not limited to the described examples.

In the crossword 640 (c=(n1, n2, n3, n4, n5)), a first node n1 corresponds to the central node. The first node, which is the central node, may be where a target statement to determine a fault suspicion value is located (e.g., parameter (ii) inputted to the PAFL module), and the processor 1030 may select the target statement and increase a suspicion value of the target statement based on the central node. A second node n2 and a third node n3 may be a predecessor sequential node and a successor sequential node, respectively, connected to the first node n1 by right-pointing arrows. A fourth node n4 and a fifth node n5 may be a predecessor branch node and a successor branch node, respectively, connected to the first node n1 by downward arrows. Each node may map (Node=Token→ [symbol] ) each token to the score to be added to the degree of suspicion of the target statement represented by the first node n1, which is the central node.

In the example, in the processor 1030, a first (central) node n1={‘if’: 0.3} of a first crossword maps the token ‘if’∈Token to the score of 0.3. A third node n3={‘y’: 0.13} maps the token ‘y’∈Token to the score of 0.13∈R, a fourth node n4={‘x’: 0.21} maps the token ‘x’ to the score of 0.21, and a fifth node n5={‘return’: 0.2, ‘y’: 0.1} maps the token ‘return’ to the score of 0.2 and the token ‘y’ to the score of 0.1.

The crossword 640 may be a function (CrossWord: [symbol] ×Stmt×Program→ [symbol] ) that receives the score of a target statement of a program (e.g., the program inputted to the PAFL module) and returns the score of an updated statement.

In the program (p∈Program), a crossword (n1, n2, n3, n4, n5)∈CrossWord may return an updated score from a given score r∈R (e.g., an initial score from the baseline fault localization method) of a statement s∈Stmt, as shown in Equation 6 below. Equation 6 is a formal statement of the notion of computing an updated score.

$$Equation 6$$

$$( {n}_{1} , {n}_{2} , {n}_{3} , {n}_{4} , {n}_{5} ) {( r , s , p )}_{} = r + {max}_{t ∈ tokens ( s )} {n}_{1} ( t ) + {max}_{t ∈ tokens ( pred ( s , p ) )} {n}_{2} ( t ) + {max}_{t ∈ tokens ( succ ( s , p ) )} {n}_{3} ( t ) {max}_{t ∈ tokens ( parent ( s , p ) )} {n}_{4} ( t ) + {max}_{t ∈ tokens ( child ( s , p ) )} {n}_{5} ( t )$$

tokens(s) denote a set of tokens of a statement s. pred(s, p) and succ(s, p) denote statements having a predecessor-successor sequential relationship with the statement s in the indentation tree 630 of the program p. parent(s, p) and child(s, p) denote statements having a vertical branch relationship with the statement s in the indentation tree 630 of the program p. In The max function selects the maximum value (another technique, described below, involves summing all token-score pairs withing a node rather than selecting the max score). When multiple token-score pairs exist within a node, the max function is applied to select only the highest score for updating the suspicion value/score. That is, the processor 1030 may increase a suspicion value for a target statement when a token, which is mapped to the score of a corresponding node, is included in a statement or adjacent statements, according to the corresponding crossword 640.

For example, in the example code 610, when the statement s1 is the target statement whose suspicion score is being updated, a token ‘return,’ which is mapped to 0.2, is included in a child (or lower) statement s6, so the crossword 640 may increase a suspicion value of the target statement s1 by 0.2. When the target statement whose suspicion score being updated is s2, the upper/parent statement s1 includes the token ‘x,’ and the successor statement s3 includes a token ‘y,’ and the corresponding third node n3={‘y’: 0.13} and fourth node n4={‘x’: 0.21} have suspicion values that are mapped to 0.13 and 0.21, respectively, so the score of the statement s2, which is the target statement, may increase by 0.34.

In this method, the max function is applied to select the highest score among token-score pairs in a node. For example, as in the example of statement s5, if a node contains scores 0.2 and 0.1, only the maximum score (0.2) is added to the suspicion value. The parent (or upper) statement s1 includes the token ‘x’ mapped to 0.21, so the suspicion values of the statements s3 and s6 (treated as target statements) each increase by 0.21. In the crossword 640, the suspicion value of the statement s4 increases the most. The statement s4 includes the token ‘if’ mapped to 0.3 and is connected, in a branch/sequential relationship, to: the statement s1 including the token ‘x’ mapped to 0.21; the statement s5 including a token ‘return’ mapped to 0.2 and a token ‘y’ mapped to 0.1; and the statement s6 including a token ‘y’ mapped to 0.13. Thus, the suspicion value of the statement s4 increases by the sum, which is 0.94. In another approach a summation function is used rather than the max function; all token-score pairs in a node are summed and added to the suspicion value. For example, if a node contains scores 0.2 and 0.1, both scores are added, resulting in a total increase of 0.3.

However, when the target statement for suspicion score calculating (updating) is s5, in the crossword 640, a token mapped to a positive score is not included in a corresponding statement and the adjacent statement s4, so the suspicion value of the statement s5 is not updated. The processor 1030 may finally update the initial suspicion values of s1, s2, s3, s4,s5, and s6 (calculated by the baseline fault localization method) through the PAFL module, as shown in Table 1 below. In Table 1, the column corresponding to s4 may be selected as a location where a fault is deemed/predicted to exist, due to having the highest adjusted suspicion score among the statements. ‘Before’ is a suspicion value calculated using the fault localization method according to the related art before applying the PAFL technique to a project, and ‘After’ is an updated suspicion value after applying the PAFL technique to the calculated suspicion value.

TABLE 1

| | s1 | s2 | s3 | s4 | s5 | s6 |
|---|---|---|---|---|---|---|
| Before | 0.44 | 0.44 | 0.44 | 0.44 | 0.57 | 0.0 |
| After | 0.64 | 0.78 | 0.65 | 1.38 | 0.57 | 0.21 |

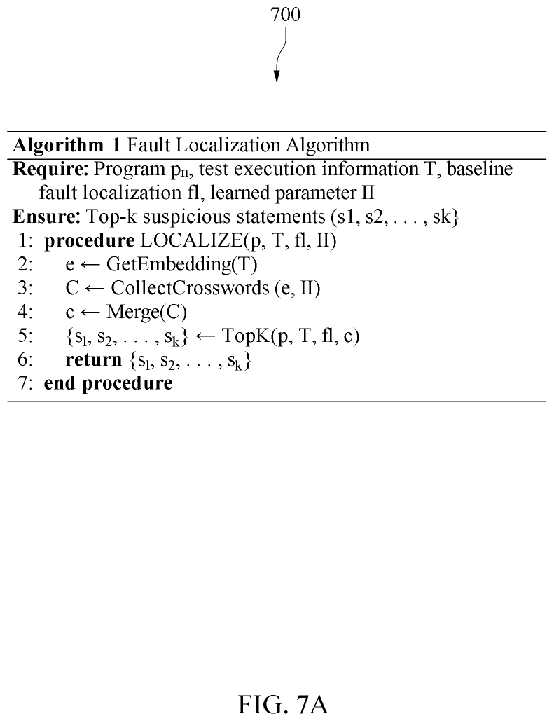

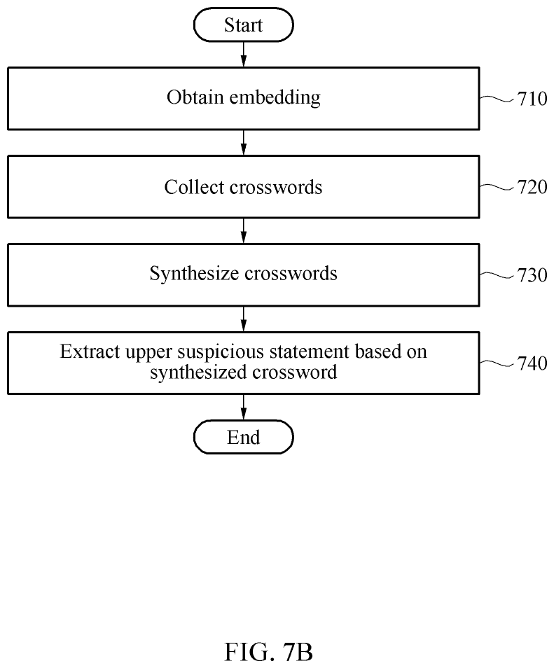

Before updating the default/baseline suspicion values, s4 has the second-highest score of 0.44, and s5 has the highest score of 0.57. However, after updating the suspicion values, s4 has the highest updated suspicion value of 1.38, and the PAFL module may determine that the first fault-suspicious statement is the s4 statement. In other words, the PAFL module may return statement s4 as a result of being invoked with the previously discussed example input parameters, where statement s4 is the statement with the highest updated suspicion score among the updated suspicion scores of the inputted program (according to the other input parameters such as the default fault localization data, the test execution result set, and the trained context set). Alternatively, as described with reference to FIGS. 7A and 7B, the PAFL module may return the statements with the top-k highest updated suspicion scores.

FIGS. 7A and 7B illustrate examples of a fault localization algorithm, according to one or more embodiments.

Referring to FIGS. 7A and 7B, a project-aware fault localization (PAFL) algorithm (hereinafter, referred to as algorithm 1 700, e.g., the PAFL module described above) may provide/return the top-k fault suspicious statements (those with the k highest updated suspicions) of an input program.

When algorithm 1 700 is executed, the processor 1030 may have, as an input of algorithm 1 700, the input program pₙ∈Program (an n^{th} version of a project) having a fault, program execution result set T⊆TestInfo, a baseline fault localization method fl∈FL, and a parameter Π∈Context trained in the past/previous version of the project. The processor 1030 may then output the top-k suspicious statements {s1, s2, . . . , sk} that are likely to be responsible for a fault in the program. A trained parameter Π={(e₁, c₁), . . . , (eₙ₋₁, cₙ₋₁)} may be a set of n−1 pairings between error embeddings and corresponding crosswords trained in n−1 past versions of the project.

In operation 710, the processor 1030 may obtain an embedding set. Referring to line 2 of algorithm 1 700, the processor 1030 may call GetEmbedding(T) and retrieve error embedding e of a given program.

In operation 720, the processor 1030 may collect crosswords. Referring to line 3 of the algorithm 1 700, the processor 1030 may collect a candidate crossword C⊆CrossWord from a given parameter={(e₁, c₁), . . . , (eₙ₋₁, cₙ₋₁)}. Each context (eᵢ, cᵢ) may be the error embedding of the past version of the project paired with a corresponding trained crossword. When the processor 1030 collects the crosswords, algorithm 1 700 may collect a crossword corresponding to an error embedding that is similar to embedding e=(mₚₐₛₛ, m_{fail}) of a given program. CollectCrosswords((mₚₐₛₛ, m_{fail}),Π) may return a crossword set C, as shown in Equation 7 below.

$$C = \{ {c}_{i} \vert ( ( {m}_{{pass}_{i}} , {m}_{{fail}_{i}} ) , {c}_{i} ) ∈ Π , Distance ( {m}_{fail} , {m}_{{fail}_{i}} ) \leq Distance ( {m}_{pass} , {m}_{{pass}_{i}} ) \} \qquad Equation 7$$

Here, Distance(m₁, m₂) denotes a Euclidean distance between two maps m₁ and m₂, as shown in Equation 8 below.

$$Distance ( {m}_{1} , {m}_{2} ) = \sqrt{{\sum }_{t ∈ Token} {( {m}_{1} ( t ) - {m}_{2} ( t ) )}^{2}} \qquad Equation 8$$

The processor 1030 may select/employ a measurement method based on the distance between maps included in embedding. When the distance between two fail maps (m_{fail} and m_{fail}_{ᵢ}) is less than the distance between a fail map and a pass map (m_{fail} and mₚₐₛₛ_{ᵢ}), two corresponding errors may be considered to be similar to each other. That is, when a failing test case handles (executes statements with) similar tokens in a program, and a passing test case handles different tokens, two errors may then be considered similar.

In operation 730, the processor 1030 may synthesize crosswords. Referring to line 4 of algorithm 1 700, the processor 1030 may merge collected crosswords

$$C = \{ {c}_{1}^{′} , {c}_{2}^{′} , … , {c}_{m}^{′} \}$$

into one crossword c.

$$Merge ( \{ {c}_{1}^{′} , {c}_{2}^{′} , … , {c}_{m}^{′} \} )$$

may return a crossword c′=(n1, n2, n3, n4, n5), and each of the five nodes n1-n5 may be determined as per the following Equation 9.

$${n}_{1} = λ t \cdot {\sum }_{i = 1}^{m} {n}_{1}^{′ i} ( t ) , {n}_{2} = λ t \cdot {\sum }_{i = 1}^{m} {n}_{2}^{′ i} ( t ) , {n}_{3} = λ t \cdot {\sum }_{i = 1}^{m} {n}_{3}^{′ i} ( t ) , {n}_{4} = λ t \cdot {\sum }_{i = 1}^{m} {n}_{4}^{′ i} ( t ) , {n}_{5} = λ t \cdot {\sum }_{i = 1}^{m} {n}_{5}^{′ i} ( t ) \qquad Equation 9$$

Here,

$${n}_{q}^{′ r} ( t )$$

denotes a q-th node of a crossword c′ᵣ. For example, it may be assumed that C is {c₁, c₂} (i.e., C={c₁, c₂}); c₁ and c₂ may be, for example, the first crossword 510 of FIG. 5 and the crossword 640 of FIG. 6, respectively. Here, the processor 1030 may execute Merge(C) and generate a synthesized crossword.

In operation 740, the processor 1030 may extract an upper suspicious statement based on the synthesized crossword. Referring to lines 5 and 6 of the algorithm 1 700, the processor 1030 may obtain the suspicion values of the statements using a baseline fault localization method fl and a synthesized crossword c′. The processor 1030 may then return the top k fault-suspicious statements

$$\{ {s}_{1}^{′} , {s}_{2}^{′} , … , {s}_{k}^{′} \}$$

of a program pₙ. TopK(p,T,fl,c′) may return k statements

$$\{ {s}_{1}^{′} , {s}_{2}^{′} , … , {s}_{k}^{′} \}$$

from the program. Each statement

$${s}_{1}^{′} ∈ \{ {s}_{1}^{′} , {s}_{2}^{′} , … , {s}_{k}^{′} \}$$

may be determined according to the following Equation 10.

$$\vert \{ {s}_{j} \vert {s}_{j} ∈ \{ {s}_{1} , … , {s}_{q} \} , {c}^{′} {( fl ( {s}_{i}^{′} , T ) , {s}_{i}^{′} , {p}_{n} )}_{} < {c}^{′} {( fl ( {s}_{j} , T ) , {s}_{j} , {p}_{n} )}_{} \} \vert < k . \qquad Equation 10$$

The user may find an actual fault in a program by examining a statement determined to be a fault-suspicious statement. For example, in a software development tool/suite, a debugger or coding environment may highlight/flag/interrupt/etc. the fault-suspicious statement. When the user corrects the actual fault in the latest version of the project pₙ, the processor 1030 may train a new crossword cₙ∈CrossWord in the revealed fault through a crossword update algorithm and update a crossword [symbol] c₁, c₂, . . . , cₙ [symbol] trained in the past version of the project pₙ. The processor 1030 may train a new parameter Π′ using the fault revealed by the user as training data, using a fault localization training algorithm. The newly trained parameter Π′ may be used to find a fault in the next version of a project pₙ₊₁. In other words, the fault related data is updated for the new (fault-corrected) version of the program.

The fault localization training algorithm is an algorithm that may, among other things, train a new crossword from a fault that is newly revealed by the user in the project, and the crossword update algorithm may update a previously trained crossword, thus continually extending fault information of a current version to fault information of a new version.

Hereinafter, the fault localization training algorithm and the crossword update algorithm are described in detail.

FIGS. 8A and 8B illustrate examples of a fault localization training algorithm, according to one or more embodiments.

When a fault localization training algorithm (hereinafter, referred to as algorithm 2 800) is executed, the processor 1030 may have, as an input of the fault localization training algorithm, the latest version of a project pₙ∈Program, program execution information T⊆TestInfo, a previously trained parameter Π∈Context used to localize a fault in a program, and an actual fault statement S⊆Stmt in the program. The processor 1030 may then train a new parameter Π′∈Context to be used when localizing a fault in the next version of a project.

In operation 810, the processor 1030 may generate a basic crossword. Referring to line 2 of algorithm 2 800, the processor 1030 may first initialize a crossword cₙ to a default value without updating a suspicion value.

In operation 820, the processor 1030 may obtain embedding of a program for training. Referring to line 3 of algorithm 2 800, the processor 1030 may execute GetEmbedding(T) and retrieve error embedding from the latest version of the project.

In operation 830, the processor 1030 may collect crosswords related to the program for training. Referring to line 4 of algorithm 2 800, the processor 1030, in Π={((e₁, e₁), (e₂, e₂), . . . , (E_{N-1}, E_{N-1}))}, may collect crosswords used to find a fault of the project pₙ in the fault localization algorithm (the algorithm 1 700).

In operation 840, the processor 1030 may train a new crossword using the program for training and update the collected crosswords. Referring to lines 5 to 9 of algorithm 2 800, the processor 1030 may update each crossword cᵢ∈C∪{cₙ} using an UPDATE function.

In operation 850, the processor 1030 may return a crossword trained for given embedding and previously trained crosswords that are updated. Referring to lines 11 and 12 of algorithm 2 800, the processor 1030 may return an updated parameter Π′={(e₁, c₁), (e₁, c₂), . . . , (eₙ, cₙ)}.

FIGS. 9A and 9B illustrate examples of a crossword update algorithm, according to one or more embodiments.

A crossword update algorithm (hereinafter, referred to as algorithm 3 900) may be referred to as an UPDATE function, may be a crossword update function. Algorithm 3 900 may aim to update a given crossword c∈CrossWord to be performed well on the latest version of a given project pₙ∈Program. Referring to line 3 of algorithm 3 900, the processor 1030 may initialize a new crossword

$$( {n}_{1}^{′} , {n}_{2}^{′} , {n}_{3}^{′} , {n}_{4}^{′} , {n}_{5}^{′} )$$

∈Crossword as a copy of a given crossword c. Referring to lines 4 to 14 of the algorithm 3 900, the processor 1030 may mutate the given crossword c and update the given crossword c when the mutation is beneficial.

Referring to lines 15 and 16 of algorithm 3 900, the processor 1030 may return an updated crossword

$${c}^{′} = ( {n}_{1}^{′} , {n}_{2}^{′} , {n}_{3}^{′} , {n}_{4}^{′} , {n}_{5}^{′} )$$

after repeating the operations described above.

More specifically, a one-crossword update algorithm is described with reference to FIG. 9B. In operation 910, the processor 1030 may collect tokens associated with a fault statement in a given program. Referring to line 4 of the algorithm 3 900, the processor 1030 may select a node nᵢ to be updated in the given crossword c. Referring to line 5 of the algorithm 3 900, the processor 1030 may obtain a set of tokens T associated with a fault statement S of the program p. TokensRelatedToFaults(p, S, i) may return the set of tokens T, as shown in Equation 11 below.

$$TokensRelatedToFaults ( p , S , i ) = \{ \begin{matrix}{⋃}_{s ∈ S} tokens ( s ) & if i = 1 \\ {⋃}_{s ∈ S} tokens ( pred ( s , p ) ) & if i = 2 \\ {⋃}_{s ∈ S} tokens ( succ ( s , p ) ) & if i = 3 \\ {⋃}_{s ∈ S} tokens ( parent ( s , p ) ) & if i = 4 \\ {⋃}_{s ∈ S} tokens ( child ( s , p ) ) & if i = 5\end{matrix} \qquad Equation 11$$

When the processor 1030 executes the TokensRelatedToFaults( ) function, the TokensRelatedToFaults( ) function may obtain the set of tokens T associated with the fault statement S. Here, the fault statement S may be helpful in localizing an actual fault(S) of the program p by updating the score mapped to a token.

In operation 920, the processor 1030 may map the collected tokens, one by one, to each of nodes of a to-be-updated crossword with a high score and collect a case in which the ranking of the actual fault(S) of a program for training increases (e.g., a ratio of increase in a node and a token). Referring to lines 6 to 13 of the algorithm 3 900, the processor 1030 may repeatedly mutate the node nᵢ using a token ω∈W and determine whether the mutation is beneficial. Referring to line 7 of the algorithm 3 900, the processor 1030 may mutate the given crossword c by updating the score mapped to the token ω∈W at the node nᵢ. Mutate((n₁, n₂, n₃, n₄, n₅), i, t) may return a new crossword

$$( {n}_{1}^{″} , {n}_{2}^{″} , {n}_{3}^{″} , {n}_{4}^{″} , {n}_{5}^{″} )$$

that satisfies the following Equation 12.

$$∀ j ∈ \{ 1 , 2 , 3 , 4 , 5 \} \cdot i \neq j ⇒ {n}_{j}^{″} = {n}_{j} , i = j ⇒ {n}_{j}^{″} ⇒ λ {w}^{′} . if {w}^{′} = w then {n}_{j} ( w ) + 1 else {n}_{j} ( w ) . \qquad Equation 12$$

When the algorithm 3 900 is executed, the processor 1030 may increase the score mapped to a token w by 1. Referring to line 9 of the algorithm 3 900, the processor 1030 may determine whether the mutation is beneficial, using a FaultStmtRanking( ) function. A FaultStmtRanking(p, T, S, fl, c) function may return the best ranking (the lower the better) of fault statements in the fault statement S when the given crossword c is used, as shown in Equation 13 below.

$$FaultStmtRanking ( p , T , S , fl , c ) = {min}_{s ∈ S} Rank ( p , T , s , f l , c ) \qquad Equation 13$$

In Equation 12, p may be [symbol] s₁, . . . , s_{q} [symbol] (i.e., p= [symbol] s₁, . . . , s_{q} [symbol] ), and Rank(p, T, s, fl, c) may be expressed as Equation 14 below.

$$Rank ( p , T , s , f l , c ) = \vert \{ {s}^{′} ε \{ {s}_{1} , … , {s}_{q} \} \vert {〚 c 〛}_{( fl ( s , T ) , s , p )} \leq {〚 c 〛}_{( fl ( {s}^{′} , T ) , {s}^{′} , p )} \vert \qquad Equation 14$$

In operation 930, the processor 1030 may update a given existing crossword based on the collected cases. Referring to line 10 of the algorithm 3 900, the processor 1030 may update a crossword c′ when the mutation is beneficial (r′<r). Referring to line 11 of the algorithm 3 900, the processor 1030 may update the score mapped to the token ω at a node n′ᵢ of the crossword c′ by

$$1 - \frac{{r}^{′}}{r} .$$

More errective mutation may further increase the score. In the described examples, a simple mutation operation and update operation are selected, but the mutation operation and update operation (line 11 of the algorithm 3 900) are not limited to the described examples.

FIG. 10 illustrates an example of an electronic device, according to one or more embodiments. Referring to FIG. 10, an electronic device 1000 may include a processor 1030, a memory 1050, and an output device (e.g., a display) 1070. The processor 1030, the memory 1050, and the output device 1070 may be connected to each other via a communication bus 1005.

The output device 1070 may display a location of a fault in a project provided by the processor 1030 together with a user interface (e.g., in a software development tool/suite).

The memory 1050 may store crosswords calculated by the processor 1030. In addition, the memory 1050 may store a variety of information generated in the processing process of the processor 1030 described above. In addition, the memory 1050 may store a variety of data and programs. The memory 1050 may include a volatile memory or a non-volatile memory. The memory 1050 may include a high-capacity storage medium such as a hard disk to store a variety of data.

In addition, the processor 1030 may perform at least one method described with reference to FIGS. 1 to 9B or an algorithm corresponding to the at least one method. The processor 1030 may be a data-processing device implemented by hardware having a circuit of a physical structure to execute desired operations. For example, the desired operations may include code or instructions included in a program. The processor 1030 may be implemented as, for example, a central processing unit (CPU), a graphics processing unit (GPU), or a neural network processing unit (NPU). The electronic device 1000 that is implemented as hardware may include, for example, a microprocessor, a CPU, a processor core, a multi-core processor, a multiprocessor, an application-specific integrated circuit (ASIC), and a field-programmable gate array (FPGA).

The processor 1030 may execute a program and control the electronic device 1000. Code of the program executed by the processor 1030 may be stored in the memory 1050.

The examples described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A fault localization method performed by one or more processors and comprising:
collecting fault data from past versions of a project that is a target of the fault localization method;
training a fault pattern based on the collected fault data;
based on a fault in a latest version of the project, generating, by applying a baseline fault localization method to the latest version of the project, first suspicion values of respective statements comprised in the latest version of the project;
obtaining a latest crossword corresponding to the latest version of the project, based on the trained fault pattern and a fault type of the latest version of the project; and
updating the first suspicion values to respective second suspicion values based on the latest crossword and the first suspicion values.

2. The fault localization method of claim 1, wherein the training of the fault pattern comprises obtaining past crosswords respectively corresponding to the past versions of the project, based on a crossword training algorithm.

3. The fault localization method of claim 2, wherein the crossword training algorithm generates an initial crossword, obtains sets of tokens for each of the past versions of the project, variously mutates the initial crossword for each of the sets of tokens to measure performance of the mutated initial crossword, and trains a crossword for each of the past versions of the project, based on the measured performance of the mutated initial crossword.

4. The fault localization method of claim 2, wherein the obtaining of the latest crossword corresponding to the latest version of the project comprises extracting at least one candidate crossword from among the past crosswords by considering a version context between the latest version of the project and the past versions of the project.

5. The fault localization method of claim 4, wherein the extracting of the at least one candidate crossword comprises selecting the at least one candidate crossword based on a similarity between a token extracted from the past versions of the project and a token extracted from the latest version of the project.

6. The fault localization method of claim 4, further comprising:
generating the latest crossword by synthesizing the at least one candidate crossword, based on a number of the at least one candidate crossword being greater than or equal to 2.

7. The fault localization method of claim 1, further comprising:
generating an indentation tree from the project and obtaining the latest crossword based on the indentation tree.

8. The fault localization method of claim 1, wherein the latest crossword is a suspicion transformation function that maps a token and a suspicion value to each of corresponding nodes in the latest crossword.

9. The fault localization method of claim 1, further comprising:
updating the latest crossword based on a crossword update algorithm based on a user input indicating a fault correction for the latest version of the project.

10. The fault localization method of claim 1, further comprising:
training the latest crossword based on a fault localization training algorithm.

11. An electronic device comprising:
one or more processors; and
a memory storing instructions configured to cause the one or more processors to:
collect fault data from past versions of a project that is a target of fault localization;
train a fault pattern based on the collected fault data;
based on a fault in a latest version of the project, generate, by applying a baseline fault localization method to the latest version of the project, first suspicion values for respective statements comprised in the latest version of the project;
obtain a latest crossword corresponding to the latest version of the project, based on the trained fault pattern and a fault type of the latest version of the project; and
update the first suspicion values to respective second suspicion values based on the latest crossword and the first suspicion value.

12. The electronic device of claim 11, wherein the instructions are further configured to cause the one or more processors to obtain past crosswords respectively corresponding to the past versions of the project, based on a crossword training algorithm.

13. The electronic device of claim 12, wherein instructions are further configured to cause the one or more processors to generate an initial crossword, obtain sets of tokens for each of the past versions of the project, variously mutate the initial crossword for each of the sets of tokens to measure performance of the mutated initial crossword, and train a crossword for each of the past versions of the project, based on the measured performance of the mutated initial crossword.

14. The electronic device of claim 12, wherein the instructions are further configured to cause the one or more processors to extract at least one candidate crossword from among the past crosswords by considering a version context between the latest version of the project and the past versions of the project.

15. The electronic device of claim 14, wherein the instructions are further configured to cause the one or more processors to select the at least one candidate crossword based on a similarity between a token extracted from the past versions of the project and a token extracted from the latest version of the project.

16. The electronic device of claim 14, wherein the instructions are further configured to cause the one or more processors to generate the latest crossword by synthesizing the at least one candidate crossword, based on a number of the at least one candidate crossword being greater than or equal to 2.

17. The electronic device of claim 11, wherein the instructions are further configured to cause the one or more processors to convert the project into an indentation tree form.

18. The electronic device of claim 11, wherein the latest crossword is a suspicion transformation function that maps a token and a suspicion value to each of nodes.

19. The electronic device of claim 11, wherein the instructions are further configured to cause the one or more processors to update the latest crossword based on a user input indicating a fault correction for the latest version of the project.

20. The electronic device of claim 11, wherein the instructions are further configured to cause the one or more processors to train the latest crossword based on a fault localization training algorithm.
